(19) United States
(12) Patent Application Publication
(10) Pub. No.: US 2013/0229575 A1
(43) Pub. Date: Sep. 5, 2013

(54) Digital TV Data Processing Method and System Thereof

(71) Applicant: MSTAR SEMICONDUCTOR, INC., Hsinchu County (TW)

(72) Inventors: Chih-Hung Lin, Hsin-Chu County (TW); Kun-chin Han, Hsin-Chu County (TW); Yu Fen Tsai, Hsin-Chu County (TW)

(73) Assignee: MSTAR SEMICONDUCTOR, INC., Hsinchu County (TW)

(21) Appl. No.: 13/778,295

(22) Filed: Feb. 27, 2013

(30) Foreign Application Priority Data
Mar. 2, 2012 (TW) 101106913

(51) Int. Cl. H04N 5/50

(52) U.S. Cl. CPC H04N 5/50
USPC 348/515; 348/731

(57) ABSTRACT

A digital TV data processing method includes: (a) when a first channel digital TV data corresponding to a first channel is displayed, storing a second channel digital TV data corresponding to a second channel, the second channel digital TV data including an audio data and a video data; (b) when the first channel is switched to the second channel, decoding the video data of the stored second channel digital TV data at a first rate; and (c) when the decoding catches up a real-time second channel digital TV data corresponding to the second channel, decoding subsequent second channel digital TV data at a second rate and displaying a corresponding real-time decoding result; wherein the first rate is higher than the second rate.

### CROSS REFERENCE TO RELATED PATENT APPLICATION

This patent application is based on Taiwan, R.O.C. patent application No. 101106913 filed on Mar. 2, 2012.

### FIELD OF THE INVENTION

The present invention relates to a digital TV data processing method and a system thereof, and more particularly, to a digital TV data processing method for increasing display fluency during a channel switch and a system thereof.

### BACKGROUND OF THE INVENTION

As technology develops, analog TV systems are gradually replaced by digital TV systems since digital TV data, compared to analog TV data, are advantageous in easy record and control, higher interference resistance ability, and higher frequency resource utilization rate, in addition to higher definition and better color display.

FIG. 1 shows a schematic diagram of a digital TV system 100 according to the prior art. The digital TV system 100 comprises an antenna 101, a tuner 103, a demodulator 105 and a decoder 109. After processed by the tuner 103 and the decoder 105, a processed result is recorded in a storage device 107. Alternatively, the processed result may be further decoded by the decoder 109 to video data and audio data, and be real-time displayed. The foregoing operations are controlled by a control unit 106. Except for the elements shown in FIG. 1, a person having ordinary skills in the art should know other elements (e.g., a filter) in the digital TV system 100 and other detailed operations, which shall not be described for brevity.

However, when the digital TV program is displayed in real time and a channel is switched to another channel, since a period of time is needed for decoding and demodulating the digital TV data to be displayed, the display of the program seems not fluent to a user while no frame is displayed for a period of time when the channel is switched to the new channel.

### SUMMARY OF THE INVENTION

Therefore, one object of the present invention is to provide a method for increasing display fluency during a channel switch and a system thereof.

According to an embodiment of the present invention, a digital TV data processing method applied to a TV display system simultaneously receiving digital TV data associated with a plurality of channels is provided. The method comprises: (a) when first channel digital TV data corresponding to a first channel are displayed, storing second channel digital TV data corresponding to a second channel, the second channel digital TV data comprising audio data and video data; (b) when the first channel is switched to the second channel, decoding from the video data of the stored second channel digital TV data at a first rate; and (c) when the decoding catches up real-time second channel digital TV data corresponding to the second channel, decoding video data of subsequent second channel digital TV data corresponding to the second channel at a second rate and displaying a corresponding real-time decoding result, wherein the first rate is higher than the second rate.

According to another embodiment of the present invention, a digital TV system comprises a video decoder, a control unit and a storage device. The control unit stores second channel digital TV data into the storage device when first channel digital TV data corresponding to a first channel are displayed, and the second channel digital TV data comprise audio data and video data. When the first channel is switched to the second channel, the video decoder decodes from the video data of the stored second channel digital TV data at a first rate, and decodes video data of subsequent second channel digital TV data corresponding to the second channel at a second rate when the foregoing decoding catches up real-time second channel digital TV data corresponding to the second channel. The control unit controls the digital TV system to display a corresponding real-time decoding result. The first rate is higher than the second rate.

Accordingly, a predetermined recorded video is rapidly decoded and displayed during a time period for processing digital TV data corresponding to a to-be-switched channel, and a digital TV program corresponding to the to-be-switched channel is then normally displayed to decrease switching disfluency.

The advantages and spirit related to the present invention can be further understood via the following detailed description and drawings.

### BRIEF DESCRIPTION OF THE DRAWINGS

FIG. 1 is a schematic diagram of a digital TV system in the prior art.

FIG. 2 is a schematic diagram of a digital TV data processing method in accordance with an embodiment of the present invention.

FIG. 3 is a schematic diagram of a remote controller of a digital TV system in accordance with an embodiment of the present invention.

FIG. 4 is a flow chart of a digital TV data processing method in accordance with an embodiment of the present invention.

### DETAILED DESCRIPTION OF THE PREFERRED EMBODIMENT

Some words referring to practical elements are applied in the specification and subsequent claims. A person having ordinary skills in the art shall comprehend, and a hardware manufacturer may use different terms to name the same elements. Functions, rather than names, of the elements are used to distinguish the elements in the specification and the subsequent claims. Moreover, the word “comprise” has an open-ended meaning as “including but not limited to” in the specification and the subsequent claims.

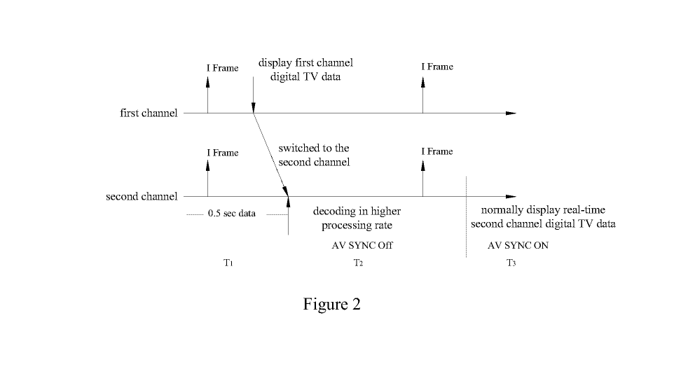

FIG. 2 shows a digital TV data processing method in accordance with an embodiment of the present invention. The first channel being currently displayed and the second channel to be displayed correspond to a same frequency point. Generally, data of a plurality of channels correspond to the same frequency point are simultaneously received. According to this embodiment, digital TV data of at least one of the other channels corresponding to the same frequency point as the current channel are stored. For example, TV data of the second channel is stored when a TV program of the first channel is displayed. The method shown in FIG. 2 is also applied to any other channels corresponding to the same frequency point as the first channel and the second channel. However, in another embodiment, the first channel and the second channel are not limited to the two channels corresponding to the same frequency point. In addition, the stored channel digital TV data are not limited to the channels corresponding to the same frequency point. In another embodiment, not all TV data of a plurality of channels corresponding to the same frequency point are stored. Since most tuners can only receive and decode digital TV data of channels corresponding to the same frequency point, at least two tuners 103 are needed to receive TV data of a channel corresponding to a different frequency point from that of the currently-displayed channel. There are different manners to select a predetermined channel to store the TV data thereof. In one embodiment, the predetermined channel may be defined by a user. In another embodiment, the frequency and total watch time of a channel is automatically recorded to generate a usage parameter to determine the predetermined channel. For example, when it is determined that the most watched channels are 5, 20 and 58 according to the frequency and total watch time of the channel, it means the user often switches between the channels. Therefore, when a TV program is currently displayed on the channel 5, TV data of the channels 20 and 58 are stored to facilitate the digital TV data processing method according to the present invention. Alternatively, the TV data of the three channels may also be stored even if other channels except for the channels 5, 20 and 58 are currently displayed.

Referring to FIG. 2, when the first channel is switched to the second channel, the decoder 109 begins to decode the stored digital TV data of the second channel in the storage device 107. The digital TV data can be divided into video data and audio data, and the digital TV system has two different sets of hardware for respectively decoding the video data and the audio data. In this embodiment, the video data of the second channel digital TV data recorded in the storage device 107 comprises a first predetermined type of frame, e.g., a start frame (frame I). In an embodiment, the digital TV system decodes and displays the first frame I (i.e., a decoding result). In another embodiment, the digital TV system does not immediately display the corresponding decoded frame I. In practical applications, when the video data of the second channel digital TV data corresponding to a time period around the frame I have high similarity, i.e., when the videos are relatively static, the user can obtain video information as soon as the frame I is displayed, so as to alleviate the disfluency in the prior art that the user has to wait for a period of time to see the frame. However, when the video data of the second channel digital TV data corresponding to the time period are greatly different, the user may feel obvious visual discontinuousness when the frame I is immediately displayed. After that, when the decoder 109 completes decoding subsequent real-time second channel digital TV data, the digital TV system switch to normally display the real-time second channel digital TV data. Specifically, during a time period T₂ after the digital TV system is switched to the second channel, the second channel digital TV data stored during a time period T₁ are first accessed and decoded, and subsequently received second channel digital TV data are then decoded. In this embodiment, the second channel digital TV data stored during the time period T₁ comprises the first frame I. During the time period T₂, the front processing units, i.e., the tuner 103 and the decoder 105, have switched to process the subsequently received second channel digital TV data comprising a second frame I, for example. After the first frame I is decoded, the digital TV system continues to decode the subsequently received second channel digital TV data with information of the first frame I. Subsequently, when a presentation time stamp (PTS) corresponding to a decoding result of a video data of the subsequently-received second channel digital TV data shows that the decoding result is synchronous with a live stream of the received TV data, that is, when the decoding result of the video data of the digital TV system catches up with the received live stream, the process enters a time period T₃. During the time period T₃, synchronization associated with the second channel digital TV data is performed, and the decoding result (comprising the decoding result of the video data and the decoding result of the audio data) of the real-time second channel digital TV data is normally displayed. A decoding rate of the digital TV system during the time period T₂ is raised, so that the decoding rate during the time period T₂ is faster than the decoding rate for processing the subsequent real-time second channel digital TV during the time period T₃.

In an embodiment, during the time period T₂, the synchronization mechanism is paused, i.e., an audio-visual synchronization (AV Sync) signal is in OFF status. The AV Sync signal is for synchronizing the audio data of the digital TV data with the video data. When the AV Sync signal is in ON status, the decoding rate cannot be raised to synchronize the decoding result of the audio data with that of the video data, so that the AV Sync is temporarily changed to the OFF status to decode the stored digital TV data at a maximum rate. In practical applications, the decoding rate is greatly raised to a maximum decoding rate due to pause of the synchronization mechanism, and generally, the maximum decoding rate can be up to three to four times of the general decoding rate, so that the decoding result of the digital TV system can catch up the received live stream in an extreme short time. When the decoding result of the digital TV system catches up the received live stream, i.e., during the time period T₃, the AV Sync signal is in the ON status to complete the decoding result for normally displaying the second channel digital TV data.

In an embodiment, the second channel digital TV data stored in the storage device 107 during a predetermined time period is processed at the beginning of the time period T₂. According to digital TV specification, the digital TV data comprises at least one frame I within every 0.5 second, so that the predetermined time period can be designed as 0.5 second; however, it shall not be construed as limiting the present invention.

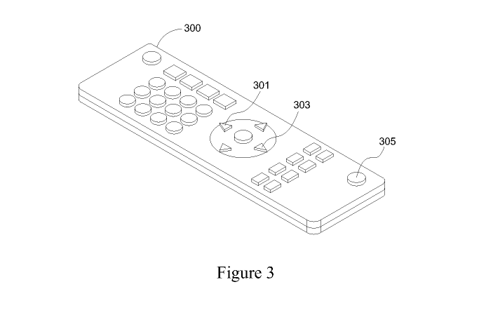

The second channel in FIG. 2 may also correspond to channel information associated with a remote controller of the digital TV system, e.g., channel information associated with a predetermined button. Taking the remote controller 300 in FIG. 3 as an example, when the first channel is displayed, once a channel up button 301 or a channel down button 303 of the control remoter 300 is pressed, the digital TV system switches the first channel to the second channel. The user may define which channel corresponds to the channel up button 301 or the channel down button 303. In another embodiment, the first channel and the second channel may both correspond to a predetermined button of a remote controller of the digital TV system. For example, the first channel and the second channel both correspond to a return button 305 of the remote controller 300 that the user may switch between the first channel and the second channel by pressing the return button 305.

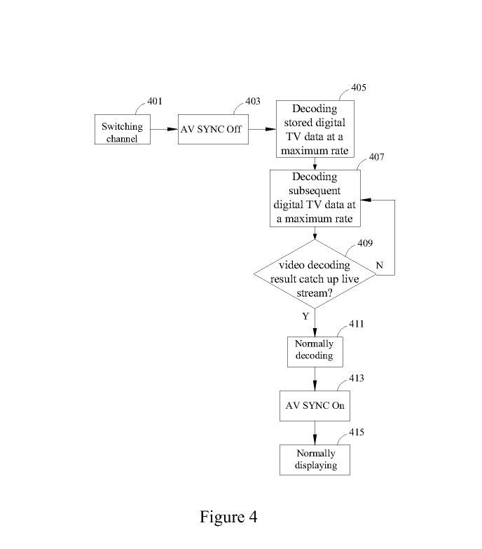

According to an embodiment of the present invention, a digital TV data processing method is provided. FIG. 4 shows a flowchart of the digital TV data processing method in accordance with an embodiment of the present invention. The flow comprises steps below. In Step 401, a channel is switched (the first channel is switched to the second channel as shown in FIG. 2). In Step 403, an AV Sync signal is in OFF status. In Step 405, a video data of a stored digital TV data is processed at a maximum rate (a video data of the second channel digital data stored in the storage device 107 during the time period T₁ is decoded at a high rate during the time period T₂ as shown in FIG. 2). In Step 407, a video decoding result is generated when a video data of a subsequently received digital TV data is processed at the maximum rate. In Step 409, it is determined whether the video decoding result catches up a live stream. The flow proceeds to Step 411 in which the decoding is performed at a normal rate when a determination result in Step 409 is yes; otherwise, the flow returns to Step 407. In Step 413, The AV Sync signal is in ON status, and synchronization of an audio data begins. In Step 415, a digital TV program comprising video and audio information is normally displayed.

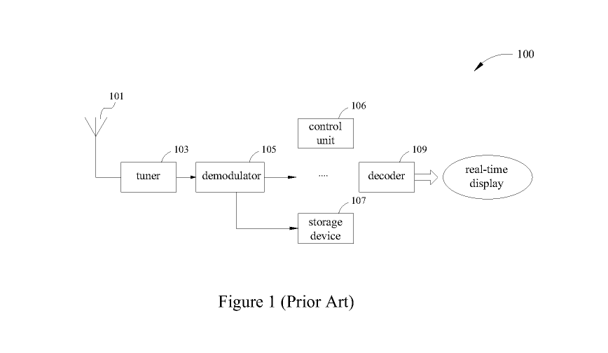

The foregoing digital TV data processing method is also applied to the digital TV system shown in FIG. 1; however, it shall not be construed as limiting the present invention.

According to the present invention, a predetermined recorded video is rapidly decoded and displayed during a time period for processing a digital TV data corresponding to a to-be-switched channel, and a digital TV program corresponding to the to-be-switched channel is then normally displayed to decrease switching disfluency.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A digital TV data processing method, applied to a TV display system simultaneously receiving digital TV data corresponding to a plurality of channels, the digital TV data processing method comprises:
(a) when first channel digital TV data corresponding to a first channel are displayed, storing second channel digital TV data corresponding to a second channel, the second channel digital TV data comprising audio data and video data;
(b) decoding from the video data of the stored second channel digital TV data at a first rate when the first channel is switched to the second channel; and
(c) when the decoding catches up real-time second channel digital TV data corresponding to the second channel, decoding video data of subsequent second channel digital TV data corresponding to the second channel at a second rate and displaying a corresponding real-time decoding result;
wherein, the first rate is higher than the second rate.

2. The method as claimed in claim 1, further comprising:
in step (b), pausing a synchronization mechanism for synchronizing the audio data and the video data of the second channel digital TV data; and
in step (c), recovering the synchronization mechanism.

3. The method as claimed in claim 1, wherein the second channel digital TV data further comprises time information of the video data, and in step (c), whether the decoding catches up the real-time second channel digital TV data corresponding to the second channel is determined according to the time information.

4. The method as claimed in claim 1, wherein the first channel and the second channel correspond to a same frequency point.

5. The method as claimed in claim 1, wherein the second channel digital TV data stored in step (a) having a predetermined type of frame during a predetermined time period.

6. The method as claimed in claim 5, wherein a video decoding result is generated in step (b), comprising a start frame corresponding to the predetermined type of frame, and subsequent decoding in step (b) and step (c) is performed according to the predetermined type of frame.

7. The method as claimed in claim 1, wherein step (b) further comprises selectively displaying a frame generated from decoding the stored second channel digital TV data.

8. The method as claimed in claim 1, further comprising:
recording frequency or watch time of a channel to generate a usage parameter; and
determining the second channel according to the usage parameter.

9. The method as claimed in claim 1, wherein the second channel corresponds to channel information associated with a remote controller of the digital TV system.

10. A digital TV system, comprising:
a video decoder;
a control unit; and
a storage device; wherein, the control unit stores second channel digital TV data comprising audio data and video data corresponding to a second channel into the storage device when first channel digital TV data corresponding to a first channel are displayed; the video decoder decodes from the stored second channel digital TV data at a first rate when the first channel is switched to the second channel, and decodes video data of subsequent second channel digital TV data corresponding to the second channel at a second rate when the decoding catches up a real-time second channel digital TV data corresponding to the second channel; the control unit controls the digital TV system to display a corresponding real-time decoding result; and the first rate is higher than the second rate.

11. The digital TV system as claimed in claim 10, wherein the control unit pauses a synchronization mechanism and recovers the synchronization mechanism until the decoding of the video decoder catches up the real-time second channel digital TV data corresponding to the second channel, and the synchronization mechanism synchronizes the audio data of the second channel digital TV data with the video data.

12. The digital TV system as claimed in claim 10, wherein the second channel digital TV data further comprises time information of the video data, and the control unit determines whether the decoding catches up the real-time second channel digital TV data corresponding to the second channel according to the time information.

13. The digital TV system as claimed in claim 10, wherein the first channel and the second channel correspond to a same frequency point.

14. The digital TV system as claimed in claim 10, wherein the storage device stores the second channel digital TV data having a predetermined type of frame during a predetermined time period.

15. The digital TV system as claimed in claim 14, wherein the video decoder generates a video decoding result comprising a start frame corresponding to the predetermined type of frame by decoding at the first rate, and video decoder performs subsequent decoding according to the predetermined type of frame.

16. The digital TV system as claimed in claim 10, wherein the control unit selectively displays a frame generated from the stored second channel digital TV data before the decoding of the video decoder catches up a real-time second channel digital TV data corresponding to the second channel.

17. The digital TV system as claimed in claim 10, wherein the control unit records frequency or watch time of a channel to generate a usage parameter, and the control unit determines the second channel according to the usage parameter.

18. The digital TV system as claimed in claim 10, further comprising a remote controller, wherein the second channel corresponds to channel information associated with the remote controller.
